(19) United States
(12) Patent Application Publication
(10) Pub. No.: US 2008/0316648 A1
(43) Pub. Date: Dec. 25, 2008

(54) Nanocryalline structured co-based alloy intermediate layer (IL) replacing ru layer in perpendicular magnetic recording media for hard disk drive

(75) Inventors: Sooyoul Hong, Santa Clara, CA (US); Carl (Xiao) Dong Che, Saratoga, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/820,588

(22) Filed: Jun. 19, 2007

(51) Int. Cl. G11B 5/127; G11B 17/02; G11B 5/84; G11B 5/147

(52) U.S. Cl. 360/125.02; 360/264; 360/97.01; 977/755; 427/131

(57) ABSTRACT

A disk for a hard disk drive. The disk includes a first magnetic layer and a second magnetic layer. An intermediate layer consisting of cobalt and titanium is located between the first and second intermediate layers. The intermediate layer creates a finer grain size and larger crystalline anisotropy in the second magnetic layer, characteristics that are desirable when used with a perpendicular recording head.

### BACKGROUND OF THE INVENTION

1. Field of the Invention

The subject matter disclosed generally relates to disk media of hard disk drives.

2. Background Information

Hard disk drives contain a plurality of heads that are magnetically coupled to rotating disks. The heads write and read information by magnetizing and sensing the magnetic fields of the disk surfaces.

There are generally two different types of magnetic heads, horizontal recording heads and perpendicular recording heads (“PMR heads”). Horizontal recording heads magnetize the disk in a direction that is essentially parallel with the outer surface of the disk. PMR heads magnetize the disk in a direction essentially perpendicular to the outer surface of the disk. PMR heads are preferred because perpendicular recording allows for higher bit densities and corresponding increases in the data capacity of the drive.

FIG. 1 shows a disk 1 of the prior art used with PMR heads. The disk 1 includes a substrate 2 that supports a first layer of magnetic material 3. The magnetic layer 3 may actually include multiple layers of magnetic material and non-magnetic material. The disk also has a second layer of magnetic material 4. The second magnetic layer may be of a harder material.

There is an intermediate layer of ruthenium 5 between the first and second magnetic layers 3 and 4. The ruthenium improves the crystallography of the second magnetic layer 4 to improve the magnetic characteristics of the disk. Ruthenium is an extremely rare element that is mined primarily in South Africa. The rareness of ruthenium increases the likelihood of price fluctuations and supply disruptions, undesirable events when mass producing disk drives. It would be desirable to provide a perpendicularly recorded disk that does not require, or reduces the requirement for, a ruthenium based intermediate layer.

### BRIEF SUMMARY OF THE INVENTION

A disk for a hard disk drive. The disk includes a first magnetic layer adjacent to a substrate. The disk also includes an intermediate layer between the first magnetic layer and a second magnetic layer. The intermediate layer consist of cobalt and titanium.

### BRIEF DESCRIPTION OF THE DRAWINGS

FIG. 1 is an illustration showing the various layers of a disk of the prior art;

FIG. 2 is a top view of a hard disk drive;

FIG. 3 is an illustration of a disk of the hard disk drive;

FIG. 4 is an illustration of an alternate embodiment of the disk.

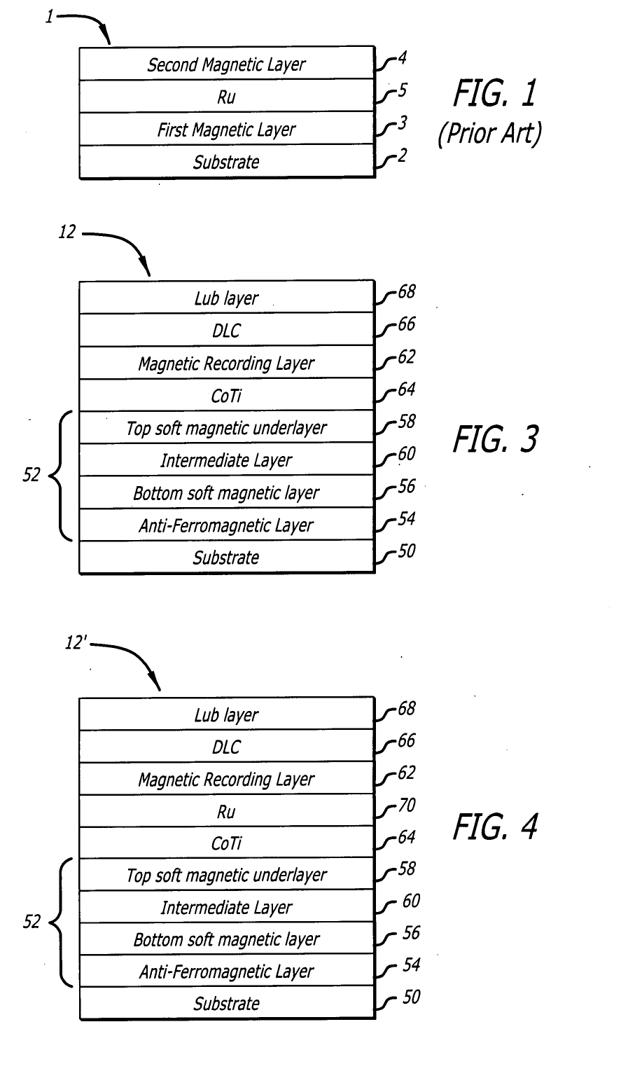

### DETAILED DESCRIPTION

Disclosed is a disk for a hard disk drive. The disk includes a first magnetic layer and a second magnetic layer. An intermediate layer consisting of cobalt and titanium is located between the first and second intermediate layers. The intermediate layer creates a finer grain size and larger crystalline anisotropy in the second magnetic layer, characteristics that are desirable when used with a perpendicular recording head. The cobalt/titanium composition is less rare than the ruthenium material used in prior art disk and is thus generally cheaper and more available than ruthenium.

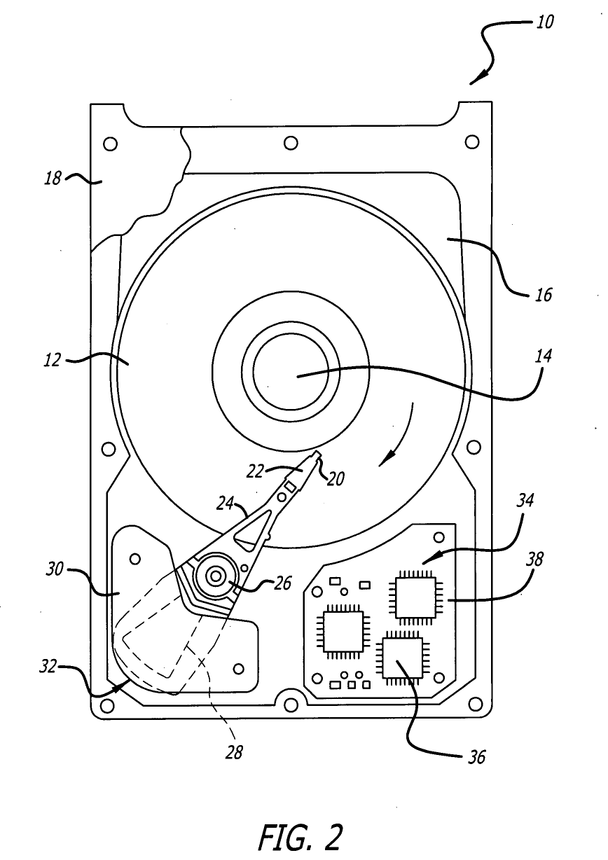

Referring to the drawings more particularly by reference numbers, FIG. 2 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

FIG. 3 shows an embodiment of the disk 12. The disk 12 includes a substrate 50 that supports a first layer of magnetic material 52. The first magnetic layer 50 may actually include a plurality of layers 54, 56, 58 and 60. Layer 54 may be a anti-ferromagnetic material located over a substrate 50. A bottom soft magnetic underlayer 56 may be located over and contiguous with the anti-ferromagnetic material 54. The bottom soft magnetic underlayer 56 may be separated from a top soft magnetic underlayer 58 by an intermediate layer 60.

By way of example, the anti-ferromagnetic material may be constructed from a platinum and manganese composition PtMn, or an iridium and manganese composition IrMn. By way of example, the IrMn may be by atomic 20% iridium and 80% manganese. The synthetic AFC type soft magnetic layers 56 and 58 are pinned by the anti-ferromagnetic layer to increase the signal to noise ratio (“SNR”). The SNR is improved by lowering the DC noise and spike noise within the soft magnetic layers 56 and 58 of the media.

It has been found that the media provides a higher SNR if the bottom soft magnetic underlayer 56 has a high magnetic saturation characteristic and the top soft magnetic underlayer 58 has a low magnetic saturation characteristic. By way of example, the bottom soft magnetic underlayer 54 may be constructed with cobalt, zirconium and niobium CoZrNb. The top soft magnetic underlayer 56 may be constructed from nickel, iron and niobium NiFeNb. The intermediate layer 60 may be constructed from ruthenium.

The media may also a second magnetic layer 62. The second magnetic layer 62 may include iron. An intermediate layer 64 consisting of cobalt and titanium is located between the first and second magnetic layers 62. The intermediate layer 64 is contiguous to the second magnetic recording layer 62 such that the cobalt/titanium affects the crystalline structure of the recording layer 62. The intermediate layer 64 interacts with the recording layer 62 to create a relatively fine grain structure with a large crystalline anisotropy. The cobalt creates crystal orientation in the (0002) plane which improves crystalline anisotropy. This provides for improved magnetic characteristics for the media. The intermediate layer of cobalt and titanium may have a nanocrystalline structure. By way of example, the thickness of the intermediate layer of cobalt and titanium may be approximately 30 nanometers. The intermediate layer may have a composition such that the titanium does not exceed 33° of the cobalt (i.e. Co₆₇Ti_{33°}). The disk may also have a protective diamond-like-carbon layer 66 and a lubricant layer 68.

FIG. 4 shows an alternate embodiment of a disk media 12′ that includes a layer of ruthenium 70 adjacent to the layer of cobalt and titanium. The ruthenium 70 may be flashed onto the cobalt/titanium layer to minimize the amount of ruthenium material. By way of example, the layer of ruthenium may be approximately angstroms thick.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A magnetic disk for a hard disk drive, comprising:
a substrate;
a first magnetic layer adjacent to said substrate;
a second magnetic layer; and, an intermediate layer consisting of cobalt and titanium located between said first and second magnetic layers.

2. The disk of claim 1, further comprising a layer of ruthenium adjacent to said intermediate layer consisting of cobalt and titanium.

3. The disk of claim 1, wherein said titanium does not exceed approximately one-third of said intermediate layer.

4. The disk of claim 1, wherein said intermediate layer of cobalt and titanium has a thickness of approximately 30 nanometers.

5. The disk of claim 1, wherein said intermediate layer of cobalt and titanium is contiguous to said second magnetic layer.

6. A hard disk drive, comprising:
a base plate;
a spindle motor coupled to said base plate;
a disk coupled to said spindle motor, said disk including;
a substrate;
a first magnetic layer adjacent to said substrate;
a second magnetic layer;
an intermediate layer consisting of cobalt and titanium located between said first and second magnetic layers;
an actuator arm mounted to said base plate;
a voice coil motor coupled to said actuator arm; and,
a head coupled to said actuator arm and said disk.

7. The hard disk drive of claim 6, further comprising a layer of ruthenium adjacent to said intermediate layer consisting of cobalt and titanium.

8. The hard disk drive of claim 6, wherein said titanium does not exceed approximately one-third of said intermediate layer.

9. The hard disk drive of claim 6, wherein said intermediate layer of cobalt and titanium has a thickness of approximately 30 nanometers.

10. The hard disk drive of claim 6, wherein said intermediate layer of cobalt and titanium is contiguous to said second magnetic layer.

11. A method for fabricating a disk of a hard disk drive, comprising:
forming a first layer of magnetic material over a substrate;
forming an intermediate layer consisting of cobalt and titanium over the first layer of magnetic material;
forming a second layer of magnetic material over the intermediate layer of cobalt and titanium.

12. The method of claim 11, further comprising forming a layer of ruthenium adjacent to the intermediate layer consisting of cobalt and titanium.

13. The method of claim 11, wherein the titanium does not exceed approximately one-third of the intermediate layer.

14. The method of claim 11, wherein the intermediate layer of cobalt and titanium has a thickness of approximately 30 nanometers.

15. The method of claim 11, wherein the intermediate layer of cobalt and titanium is contiguous to the second magnetic layer.
